(19) United States
(12) Patent Application Publication
(10) Pub. No.: US 2010/0135556 A1
(43) Pub. Date: Jun. 3, 2010

(54) METHOD AND SYSTEM FOR OUTLINING A REGION IN POSITRON EMISSION TOMOGRAPHY STUDIES

(76) Inventors: Pasha Razifar, Uppsala (SE); Anna Ringheim, Sao Paulo (BR); Bengt Longstrom, Uppsala (SE); Henry Engler, Uppsala (SE); Anders Wall, Uppsala (SE)

Correspondence Address: GE HEALTHCARE, INC., IP DEPARTMENT 101 CARNEGIE CENTER, PRINCETON, NJ, 08540-6231, US

(21) Appl. No.: 12/447,270

(22) PCT Filed: Oct. 25, 2007
(86) PCT No.: PCT/IB07/03212

§ 371 Date: Jan. 13, 2010

Related U.S. Application Data
(60) Provisional application No. 60/854,526, filed on Oct. 26, 2006.

(51) Int. Cl. G06K 9/48; G06T 7/00

(52) U.S. Cl. 382/131; 382/199

(57) ABSTRACT

In a method and system for outlining a region of interest in a Positron Emission Tomography (PET) scan study, a processor may, based on application of Masked Volume Wise Principal Component Analysis (MVW-PCA) to a plurality of scan images, generate a PC2 image showing kinetic behavior of a particular part of a subject, in particular, the grey matter of the cerebellar cortex of the subject, and may outline, in the PC2 image, a region of the PC2 image having highest pixel intensity values of the PC2 image or of a portion thereof as a region of interest, and, in particular, as a reference region. The processor may generate a PC3 image showing kinetic behavior of a different part of the subject, in particular, blood vessels of the subject, import the outline into the PC3 image to determine the correctness of the outline, and modify the outline if it is incorrect.

### FIELD OF THE INVENTION

The present invention relates to a method and system for outlining a region, in particular a reference region, in Positron Emission Tomography (PET) studies. The present invention further relates to a method and system for automatic outlining of the reference region.

### BACKGROUND INFORMATION

PET is a conventionally known specialized imaging technique that uses tomography to computer-generate a three-dimensional image or map of a functional process in the body as a result of detecting photons when artificially introduced radionuclides (tracer) incorporated into biochemical substances decay and emit positrons. Analysis of the photons detected from the deterioration of these positrons is used to generate the tomographic images which may be quantified using a color scale to show the diffusion of the biochemical substances in the tissue indicating localization of metabolic and/or physiological processes. For example, radionuclides used in PET may be a short-lived radioactive isotope such as Flourine-18, Oxygen-15, Nitrogen-13, and Carbon-11 (with half-lives ranging from 110 minutes to 20 minutes). The radionuclides may be incorporated into biochemical substances such as compounds normally used by the body that may include, for example, sugars, water, and/or ammonia. The biochemical substances may then be injected or inhaled into the body (e.g., into the blood stream) where the substance (e.g., a sugar) becomes concentrated in the tissue of interest where the radionuclides begin to decay emitting a positron. The positron collides with electron producing photons which can be detected and recorded indicating where the radionuclide was taken up into the body. This set of data may be used to explore and depict anatomical, physiological, and metabolic information in the human body. While alternative scanning methods such as Magnetic Resonance Imaging (MRI), Functional Magnetic Resonance Imaging (fMRI), and Computed Tomography (CT) may be used to isolate anatomic changes in the body, PET may use administrated radiolabeled molecules to detect molecular detail even prior to anatomic change.

PET studies in humans are typically performed in either of two modes, providing different sets of data. A first mode is whole body acquisition whereby static data for one body sector at a time is sequentially recorded to produce a plurality of slices of a three dimensional image, where each slice (also referred to herein as a frame) includes a corresponding two dimensional image surface. A second mode is dynamic acquisition whereby a same sector or brain is sequentially scanned at different points in time to produce a plurality of three dimensional images of the same sector or brain, where each three dimensional image includes a plurality of frames. The two dimensional surface images of the frames can be regarded as multivariate images from which physiological, biochemical, and functional information can be derived by analyzing the distribution and kinetics of administrated radiolabelled molecules. Each of the two dimensional images in the sequence displays/contains part of a kinetic information.

PET studies can be used, e.g., for early detection of Alzheimer's Disease (AD), since the tracer uptake in various parts of an AD patient's brain is different than in a healthy person's brain. For example, part (a) of FIG. 1 illustrates tracer uptake over time in different parts of a typical AD patient's brain and part (b) of FIG. 1 illustrates tracer uptake over time is a typical healthy person's brain. A comparison of the two graphs shows that the tracer washes out from the grey matter frontal cortex region of a healthy person's brain at a significantly quicker pace than from the same region of an AD patient's brain. Furthermore, the comparison shows that the later PET frames will show a dominance of white matter for the healthy person, but a dominance of grey matter for the AD patient.

For analysis of a patient's brain based on PET images, regions of interest (ROI) are drawn in the PET scans. ROIs of an AD patient are compared to ROIs of a database of PET images of brains of healthy volunteers (HV). It is therefore required to outline the various ROIs in the PET scans.

Variations in the PET images can be due to factors other than variations in the tracer uptake. For example, other factors can be differences in precise positioning of the subject in the PET scanner and/or differences in the PET scanners used. A reference region where there are no receptors to which the ingested tracer can bind, so that the tracer quickly washes out the region in both AD patients and HVs, is outlined and used as a baseline to which to compare pixel intensities of other regions. For example, using amyloid imaging agent Pittsburgh Compound-B (¹¹C-PIB) as the PET tracer, a reference region may be the grey matter region of the cerebellum, since, as shown in FIG. 1, with respect to both AD patients and HVs, the tracer enters the region and quickly washes out.

Due to limitations in the amount of radioactivity administered to the subject, a usually short half-life of the radionuclide, and limited sensitivity of the recording system, PET images are typically characterized by a rather high level of noise. This, together with a high level of non-specific binding to the target and sometimes small differences in target expression between healthy and pathological areas, are factors which make the analysis of PET data difficult independent of the utilized radionuclide or type of experiment. This means that the individual images are not optimal for the analysis and visualization of anatomy and pathology. One of the standard methods used for the reduction of the noise and quantitative estimation in dynamic PET data is to take the sum, average, or mean of the images, e.g., of corresponding frames, of the whole sequence or part of the sequence where the specific signal is proportionally larger.

The summed images are used for manual outlining of regions. The outlines are then applied to other frames for PET analysis in the frames to which the outlines are applied. For example, with respect to the reference region, two summed images, an “early summation image” and a “late summation image” may be produced for the frames corresponding to the cerebellum (e.g., for a PET tracer for which the reference region is the grey matter area of the cerebellum). The early summation image is a sum of corresponding frames of scans performed at an early time period of the PET scanning, and the late summation image is a sum of corresponding frames of scans performed at a later time period of the PET scanning. For example, FIG. 1 indicates that grey matter dominates the images of the early time period and white matter is significantly more dominant in the later time period than in the early time period. By comparing or superimposing the early and late summation images, a technician can manually outline the reference region, since the late summation image indicates a portion of the early summation image attributable to white matter. The reference region can be outlined to exclude the white matter region so that the grey matter region of the cerebellum is, for the most part, all that is left within the outlined area. For example, FIG. 2 illustrates an early summation image 200 (part (a)), a late summation image 205 (part (b)), and a manually outlined reference region 210 (part (c)).

However, though sum, average, or mean images may be effective in reducing noise, these approaches result in dampening of the differences detected between regions with different kinetic behavior. Therefore, aside from the tediousness of manually outlining the reference region in the explained manner, outlining of the reference region by comparison of the early and late summation images is also imprecise. This impreciseness affects results obtained when using kinetic modeling, in which a reference region is used as an input to a function for generating parametric images for further exploration and quantification.

### SUMMARY

Embodiments of the present invention provide a method and/or system that provides for outlining of regions of interest, and, in particular, a reference region, in PET studies in a manner that is significantly less tedious than by comparison between early and late summation images. Embodiments of the present invention provide a method and/or system that provides for outlining of regions of interest, and, in particular, a reference region, in PET studies in a manner that is significantly more precise than by comparison between early and late summation images. Embodiments of the present invention provide a method and/or system that provides for an automated outlining of regions of interest, and, in particular, a reference region, in PET studies. Embodiments of the present invention are related, in particular, to outlining of a reference region in PET studies using a PIB tracer.

According to an example embodiment of the present invention, a method for outlining a region of interest in a PET scan study may provide for scanning at least a part of a subject a plurality of times over a period of time that includes a plurality of sub-periods. Each scanning may generate corresponding data representing an image of the at least the part of the subject, where the image is defined by pixel intensities. Images represented by data generated during scans of different sub-periods may accentuate different features of the at least the part of the subject. The method may further provide for generating data representing an image having pixel intensities derived at least mostly from one or more images generated by the scanning of a single one of the sub-periods, determining which region of at least a portion of the image having the derived pixel intensities includes substantially higher pixel intensity values than other pixel intensity values of the at least a portion, and marking a perimeter of the determined region as a region of interest outline.

In one example embodiment of the method, the images represented by the data generated by the scanning and the derived image may be three dimensional images. The method may further provide for selecting a two dimensional image from the three dimensional derived image. The determining may be performed with respect to the selected two dimensional image.

In one example embodiment of the method, the selecting may include discriminatorily selecting a predetermined subset of two dimensional images from the three dimensional derived image, and the determining may be performed separately for each of the selected two dimensional images. The method may further provide for determining which particular one of the determined regions includes a largest surface area compared with the other of the determined regions, and discriminatorily selecting the determined particular one of the determined regions for application of the marking the perimeter.

In one example embodiment, the method may further provide for administering a PET tracer for ingestion. The scanning may be performed after the ingestion. The administered tracer may be one that interacts, in a manner detectable by a scanner with which the scanning is performed, with different parts of the subject during the period of time during which the scanning is performed. The plurality of sub-periods may substantially correspond to changes in the tracer's interaction in the detectable manner with the parts of the subject.

In one example embodiment of the method, the single one of the sub-periods on which the derived image may be mostly based may substantially correspond to domination of interaction by the tracer with a part of the subject predetermined to include the determined region.

In one example embodiment of the method, the sub-periods may include a first sub-period dominated by interaction of the tracer in the detectable manner with a blood stream, a second sub-period dominated by interaction of the tracer in the detectable manner with grey matter areas of the subject's brain, and a third sub-period in which interaction of the tracer in the detectable manner with white matter areas of the subject's brain is more dominant than in the first and second sub-periods.

In one example embodiment of the method, the tracer may be a PIB tracer, the second sub-period may be used as the single one of the sub-periods, and the outline may be of a grey matter cerebellum region.

In one example embodiment of the method, the outlined region may be usable as a reference region for a brain study to detect Alzheimer's disease.

In one example embodiment of the method, the data representing the image having the derived pixel intensities may be derived via Masked Volume Wise Principal Component Analysis (MVW-PCA).

In one example embodiment of the method, the data representing the image having the derived pixel intensities may be derived solely from the one or more images generated by the scanning of the single one of the sub-periods.

In one example embodiment, the method may further provide for generating data representing an image having pixel intensities derived at least mostly from one or more images generated by the scanning of one of the sub-periods different than the single one of the sub-periods, importing the outline into the image having the pixel intensities derived at least mostly from the one or more images generated by the scanning of the different sub-period, determining which region of at least a portion of the image having the pixel intensities derived at least mostly from the one or more images generated by the scanning of the different sub-period includes substantially higher pixel intensity values than other pixel intensity values of the at least a portion of the image derived at least mostly from the different sub-period, determining whether the outline overlaps the determined region of the image derived at least mostly from the different sub-period, determining whether the outline is correct based on the determination of whether the outline overlaps; and modifying the outline if it is determined that the outline is incorrect.

In one example embodiment of the method, the determined region of the at least a portion of the image having the pixel intensities derived at least mostly from the one or more images generated by the scanning of the different sub-period may include a plurality of regions.

In one example embodiment of the method, the determined region of the at least a portion of the image having the pixel intensities derived at least mostly from the one or more images generated by the scanning of the different sub-period may represent one or more blood vessels.

According to an example embodiment of the present invention, a computer-readable medium may have stored thereon instructions adapted to be executed by a processor. The instructions, when executed, may cause the processor to perform a method for outlining a region of interest in a PET scan study. The method may provide for, during each of a plurality of scans of at least a part of a subject performed over a period of time that includes a plurality of sub-periods, generating corresponding data representing an image of the at least the part of the subject, where the image is defined by pixel intensities. Images represented by data generated during scans of different sub-periods may accentuate different features of the at least the part of the subject. The method may further provide for generating data representing an image having pixel intensities derived at least mostly from one or more images generated by the scanning of a single one of the sub-periods, determining which region of at least a portion of the image having the derived pixel intensities includes substantially higher pixel intensity values than other pixel intensity values of the at least a portion, and marking a perimeter of the determined region as a region of interest outline.

According to an example embodiment of the present invention, a system for outlining a region of interest in a PET scan study may provide a scanner for scanning at least a part of a subject a plurality of times over a period of time that includes a plurality of sub-periods. Each scanning may generate corresponding data representing an image of the at least the part of the subject. The image may be defined by pixel intensities. Images represented by data generated during scans of different sub-periods may accentuate different features of the at least the part of the subject. The system may further provide an arrangement for generating data representing an image having pixel intensities derived at least mostly from one or more images generated by the scanning of a single one of the sub-periods, an arrangement for determining which region of at least a portion of the image having the derived pixel intensities includes substantially higher pixel intensity values than other pixel intensity values of the at least a portion, and an arrangement for marking a perimeter of the determined region as a region of interest outline.

In one example embodiment of the system, the images represented by the data generated by the scanning and the derived image may be three dimensional images. The system may further provide an arrangement for selecting a two dimensional image from the three dimensional derived image. The determining may be performed with respect to the selected two dimensional image.

In one example embodiment of the system, the selecting may include discriminatorily selecting a predetermined subset of two dimensional images from the three dimensional derived image. The determining may be performed separately for each of the selected two dimensional images. The system may further provide an arrangement for determining which particular one of the determined regions includes a largest surface area compared with the other of the determined regions, and an arrangement for discriminatorily selecting the determined particular one of the determined regions for application of the marking the perimeter.

In one example embodiment of the system, the scanning may be performed after ingestion of a PET tracer. The tracer may interact, in a manner detectable by the scanner, with different parts of the subject during the period of time. The plurality of sub-periods may substantially correspond to changes in the tracer's interaction in the detectable manner with the parts of the subject.

In one example embodiment of the system, the single one of the sub-periods may substantially correspond to domination of interaction by the tracer with a part of the subject predetermined to include the determined region.

In one example embodiment of the system, the sub-periods may include a first sub-period dominated by interaction of the tracer in the detectable manner with a blood stream, a second sub-period dominated by interaction of the tracer in the detectable manner with grey matter areas of the subject's brain, and a third sub-period in which interaction of the tracer in the detectable manner with white matter areas of the subject's brain is more dominant than in the first and second sub-periods.

In one example embodiment of the system, the tracer may be a PIB tracer, the second sub-period may be used as the single one of the sub-periods, and the outline may be of a grey matter cerebellum region.

In one example embodiment of the system, the outlined region may be usable as a reference region for a brain study to detect Alzheimer's disease.

In one example embodiment of the system, the data representing the image having the derived pixel intensities may be derived via MVW-PCA.

In one example embodiment of the system, the data representing the image having the derived pixel intensities may be derived solely from the one or more images generated by the scanning of the single one of the sub-periods.

In one example embodiment, the system may further provide an arrangement for generating data representing an image having pixel intensities derived at least mostly from one or more images generated by the scanning of one of the sub-periods different than the single one of the sub-periods, an arrangement for importing the outline into the image having the pixel intensities derived at least mostly from the one or more images generated by the scanning of the different sub-period, an arrangement for determining which region of at least a portion of the image having the pixel intensities derived at least mostly from the one or more images generated by the scanning of the different sub-period includes substantially higher pixel intensity values than other pixel intensity values of the at least a portion of the image derived at least mostly from the different sub-period, an arrangement for determining whether the outline overlaps the determined region of the image derived at least mostly from the different sub-period, an arrangement for determining whether the outline is correct based on the determination of whether the outline overlaps, and an arrangement for modifying the outline if it is determined that the outline is incorrect.

According to an example embodiment of the present invention, a method for outlining a region of interest in a PET scan study may provide for dividing a plurality of scanned images into groups corresponding to different defined periods of scan time, performing MVW-PCA on the plurality of scanned images to generate an image emphasizing images of one of the groups, and marking an outline in the generated image solely based on pixel intensity values of the generated image.

### BRIEF DESCRIPTION OF THE DRAWINGS

FIG. 1 includes graphs comparing tracer uptake over time in different parts of a brain of an AD patient and a HV.

FIG. 2 illustrates early and late summation images, and a reference region outline obtained via comparison of the early and late summation images.

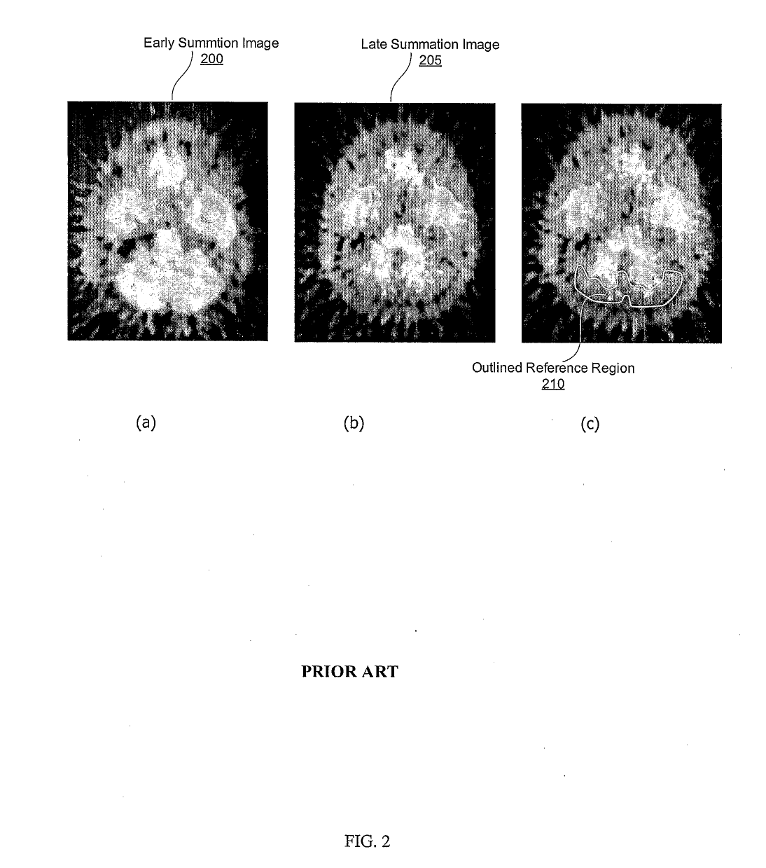

FIG. 3 is a block diagram that illustrates example components of a system for implementation of an example embodiment of the present invention.

FIG. 4 is a flowchart that illustrates an example method that may be performed to outline a region of interest, according to an example embodiment of the present invention.

FIG. 5 is a diagram that illustrates a procedure for generating a Principal Component (PC) image in an example embodiment of the present invention.

FIG. 6 illustrates an outlined region and importation of the outline into a PC3 image to determine whether the delineation of the region is correct and does not cover blood vessels, according to an example embodiment of the present invention.

### DETAILED DESCRIPTION

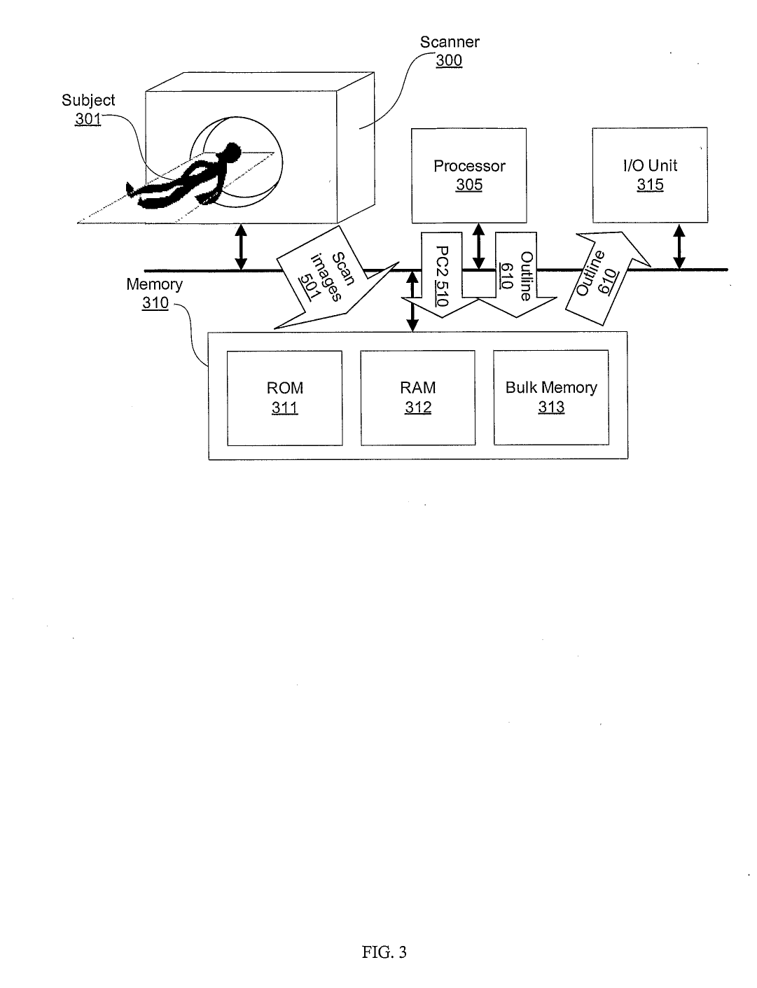

FIG. 3 is a block diagram that illustrates an example system according to an example embodiment of the present invention. A PET scanner 300 may be operated to generate multiple frames of a brain of a subject 301. Any suitably appropriate PET scanner may be used. For example, the scanner may be a Siemens ECAT HR+tomograph. The generated frames may be stored in a memory 310. The memory 310 may include any combination of conventional memory circuits, including electrical, magnetic, and/or optical systems. The memory 310 may include, for example, read only memory (ROM) 311, random access memory (RAM) 312, and/or bulk memory 313.

The memory 310 may have stored therein program instructions to be executed by a processor 305 for providing a modified PET image in which to outline a region of interest, e.g., a reference region, and/or for outlining the region of interest. The instructions may identify images in the memory 310 obtained from the scanner 300. For example, the image identification may be based on received user input indicating a particular stored PET study for which an outlined reference region is desired. The program instructions may be written in any suitable appropriate computer language, e.g., Matlab. The processor 305 may be any one or combination of suitably appropriate processing systems, such as, for example, a microprocessor, a digital signal processor, and a field programmable logic array. The processing system may be embodied as any suitably appropriate computing device, e.g., a computer, personal digital assistant (PDA), laptop computer, notebook computer, a hard-drive based device, or any device that can receive, send, and store data. An input/output (I/O) unit 315 may be provided for receiving user input and/or for providing output to a user. The I/O unit 315 may also be a conduit via which data may be transferred to and/or from other devices, e.g., over a network. The I/O unit 315 may include a display device for display of a PET scan image provided for drawing therein the region of interest, e.g., the reference region, by the user. The I/O unit 315 may include a device for receiving input from the user of an outline of the region. For example, the device may include a mouse or touch sensitive interface. Alternatively, the display device may be for providing an image having therein an automatically outlined region and/or images for PET analysis into which the automatically outlined region may be imported.

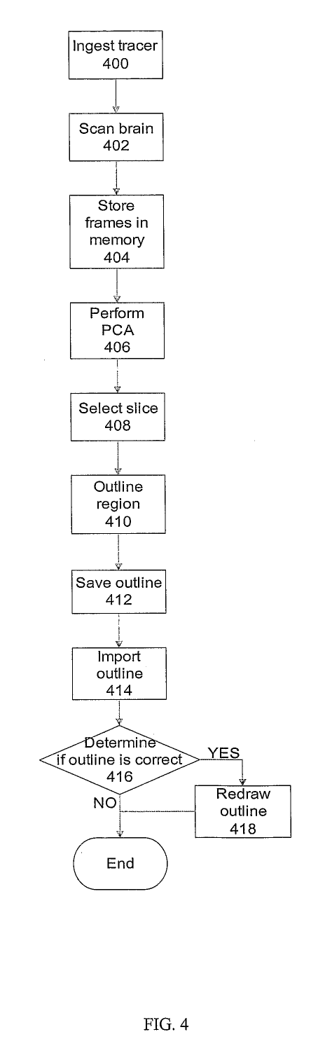

FIG. 4 is a flowchart that illustrates a method for outlining a reference region in a PET scan frame, according to an example embodiment of the present invention. At 400, a subject may ingest a PET tracer, e.g., a PIB tracer. At 402, the subject's brain may be scanned multiple times over time, e.g., 60 to 90 minutes, in a PET scanner to generate images having frames. (Alternatively, each scan may generate a single two dimensional frame.) At 404, the generated frames may be stored in the memory 310. The frames may be stored in a file or folder that represents a particular PET study or particular subject's scan. Alternatively, the frames may be independently stored with file names indicating the particular study and/or image to which the frames belong. The frames may be stored in a manner that indicates each frame's place in the sequence of the scan. The indication may also be of the particular (at least approximately) brain slice represented by the frame. For example, the order in which the frames are stored may serve as the indication. Alternatively, a frame's file name may provide the indication.

Subsequently, another image may be derived from the stored images (i.e., the stored frames of the scanned images). That is, the pixel intensity values of this other image may be derived from pixel intensity values of the stored images, with an emphasis placed on an image or images of a scan period with significant uptake, or change in uptake, in grey matter areas of the brain. For example, in one embodiment, this other image may be derived solely on a change in pixel values of images of the period during which there is greatest grey matter uptake, or change therein. In one example embodiment, this other image may be based mostly on one or more images of said period, but partly based on intensity values of images of other periods. The difference in the extent to which this other image is based on the scan images may be by the assignment of different weights to the images of different periods.

For example, in one embodiment as represented in FIG. 4, at 406, a PCA, e.g., a MVW-PCA in which the background of the images is masked out, may be performed on the images stored at 404 to generate and store a PC image that corresponds to the period of time during which there is most significant tracer uptake in the grey matter areas of the brain, i.e., subsequent to uptake into and washout from the blood stream and prior to a period in time during which the ratio of white matter area uptake to grey matter area uptake is considerably greater than the period corresponding to the PC image to be generated. This particular PC image is referred to herein as a PC2 image. A PC image corresponding to the period in time during which white matter area uptake is more significant is referred to herein as a PC1 image, and a PC image corresponding to the period in time during which uptake is significant in the blood stream is referred to herein as a PC3 image.

For PCA, all frames of a scan, e.g., 63 (number of frames per complete brain)×24 (number of complete brain scans performed over time during a single scanning period of a PET study), may be considered. The 24 complete scans may be divided into approximate time periods corresponding to blood stream uptake (period 1), grey matter uptake (period 2), grey matter washout prior to white matter washout (period 3), and/or other time periods. For each of the three (or more) time periods, a new image may be generated, where an intensity of each pixel of the new image represents a variance in pixel intensity of a corresponding pixel in the images of the period.

The resultant, for example, 3 images may be assigned different weight factors with which the pixels of the 3 images may be multiplied. The weighted images may be summed to produce a PC image. The different weights may be for stressing the kinetic properties of the tracer during a particular time period, while still taking into consideration data of all of the time periods. For example, for the PC2 image, a highest weight may be assigned to period 2, corresponding to uptake in the grey matter areas when the grey matter uptake dominates the white matter uptake.

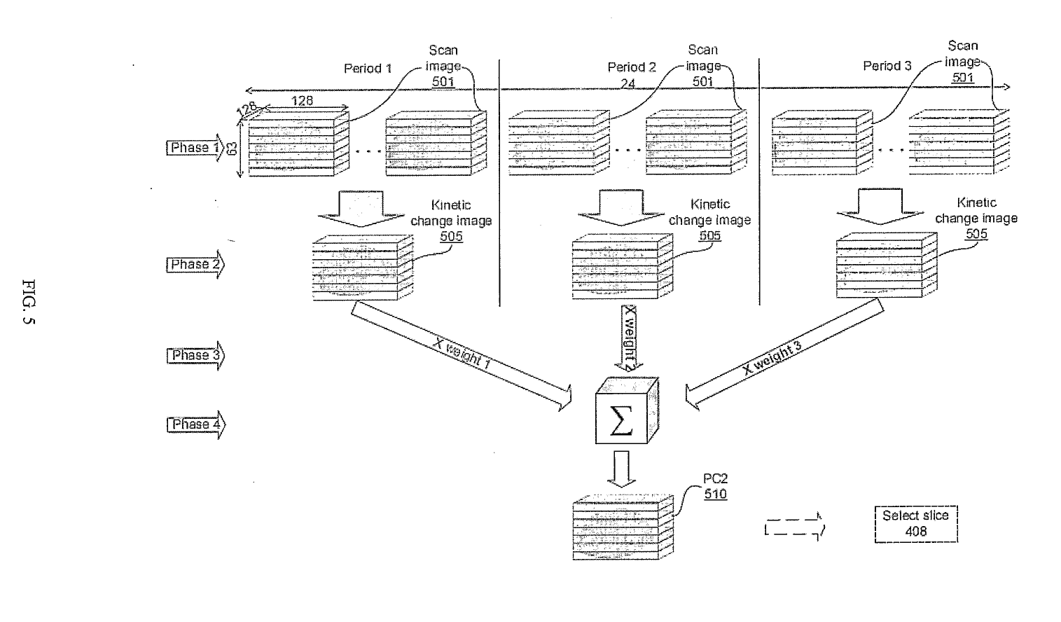

FIG. 5 illustrates an exemplary generation of the PC2 image performed at 406. In the example of FIG. 5, in phase 1, a subject's brain is scanned 24 times in a length of time divided into 3 periods. Each scan is shown to include a scan image 501 of 63 frames, each of 128×128 pixels. The number of scans, frames, pixels, and periods (i.e., 24, 63, 128×128 and 3) are exemplary.

In phase 2, the difference in pixel intensity values between the beginning and end of each period may be determined. The value of the change in each pixel's intensity may be used to obtain a new corresponding pixel intensity value. The value may be of a variance in the intensity through the images of the period. The new values may be used to construct a single new scan as a kinetic change image 505 of 63 frames for each of the periods. (The newly obtained values need not actually be output as an image.)

In phase 3, the intensity values of each period's newly obtained scan may be multiplied with corresponding weights to produce yet another modified image (not shown). The weights may be predetermined or manually set by inputting data. The highest weight value may be that of weight 2 of period 2 if period 2 approximately corresponds to the time during which grey matter uptake dominates.

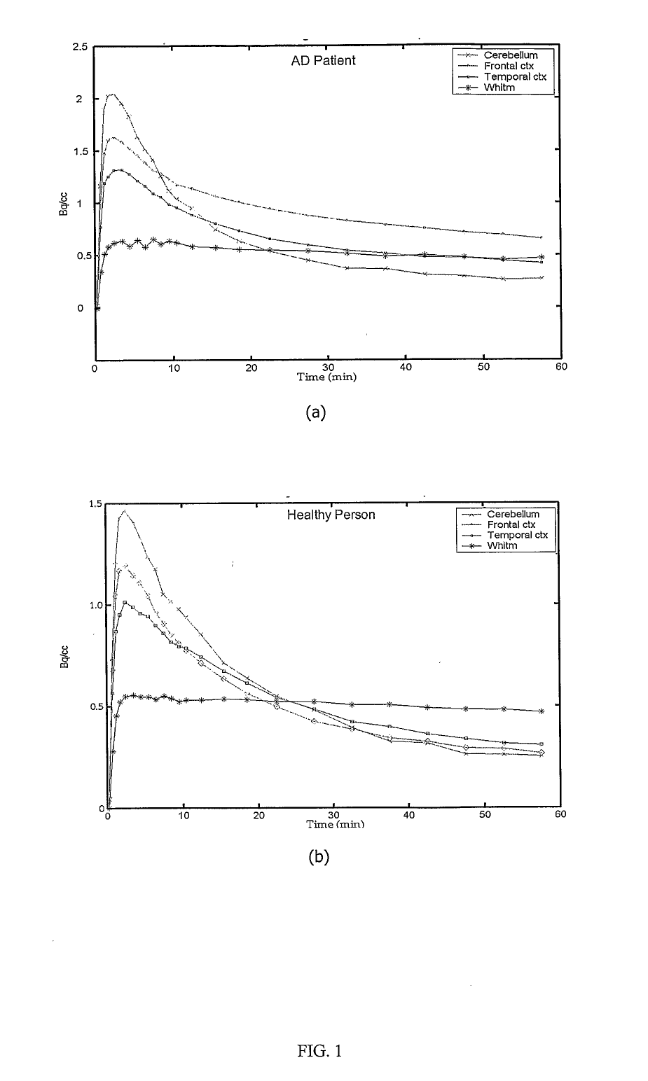

With respect to period 3, the weight 3 applied to the scan of an AD patient may be different than that of a HV. For example, a positive weight may be assigned in the case of the AD patient, since grey matter uptake dominates even in period 3, but a negative weight may be assigned in the case of the HV, since white matter uptake dominates in period 3 as shown in FIG. 1.

In phase 4, the intensity values of the pixels of the 3 weighted scans may be summed to produce a single PC2 image 510. The PC2 image 510 differs from an early summation image at least in that the pixel intensities of the PC2 image 510 are greatly dominated by grey matter uptake and clearly demarcate the areas in which there is such grey matter uptake from the other areas in which there is other uptake, since the weight factors applied to period 2 accentuate kinetic behavior in the grey matter areas. This accentuation is attributable to the significant change that occurs to intensity values due to grey matter uptake in period 2.

Referring again to FIG. 4, after performance of PCA to produce at least the PC2 image 510, a slice in which a greatest surface area of the pixels (i.e., of the 128×128 pixels in this example) demarcated by high pixel intensity values may be selected, at 408, for outlining of the reference region. That is, more of the grey matter area of the cerebellum may be represented in a frame at a first level than in a frame at a second level, since the grey matter area of the cerebellum is not perfectly cube shaped. At 410, the region of the slice in which the pixels having the greatest intensity values are located may be outlined as the reference region. Aside from the reference region, the slice may include other small regions that have high pixel intensity values. However, the other regions are usually substantially smaller than the reference region. Therefore, in an embodiment of the present invention, small regions of high pixel intensity may be excluded from demarcation as the reference region. The organ represented by the largest area of high pixel intensity values in the frame may be outlined as the reference region. The outlining does not require drawing an outline in an image, but can instead include marking as the outline data representing pixels at a perimeter of the region in which the pixels having the greatest intensity values are located.

The selection and outlining at 408 and 410 may be performed manually by using an input device of the I/O unit 315 to draw an outline of the region of a slice of the PC2 image 510 including the greatest pixel intensities. In regards to frame selection at 408, this may be performed by visually discerning which slice includes the greatest reference region surface area.

As explained above, it may occur that a PC2 image 510 includes regions representing grey matter brain regions, other than that of the cerebellum, in which there are high pixel intensities. Therefore, for frame selection and outlining of the reference region, it may be required to limit selection to a predetermined, for example, three dimensional, section of the PC2 image 510. That is, the discriminatory selection and outlining may be with respect to both 408 (selection along the vertical plane) and 410 (selection along the horizontal plane). For example, it is known that the grey matter area of cerebellum is limited to particular ones of the frames and that the grey matter area of the cerebellum does not extend into a half within the frames that represents the front portion of the brain.

To efficiently select the frames, some frames of the PC2 image 510 can be discarded (with respect to reference region selection) even without considering the frames' pixel intensities, since it is known that the greatest surface area of the representation of the grey matter area of the cerebellum is never or is almost never found in these frames.

In an alternative embodiment, the selection at 408 and outlining at 410 may be automated. The system may measure the pixel intensity values of those of the PC2 image frames predetermined to be most relevant to determine in which of the predetermined frames there is a greatest surface area of high pixel intensities in the cerebellum region. This region of this frame may be selected and outlined automatically as the reference region.

The outline may be of a two dimensional region, or, as required, of a three dimensional region of one or more frames.

While the example represented by the flowchart of FIG. 4 is of a generation of a PC2 image 510, of selection of a frame thereof, and of selection and outlining of a reference region therein, other PC images may be used instead, i.e., PC images accentuating regions in which there is greatest tracer uptake during other periods of time, to outline other regions of interest. Further, even with respect to the PC2 image, the frame selection and region outlining at 408 and 410 may be of different frames and/or different portions of the selected frames for outlining of different regions of interest.

While it has been proven that the PC2 image 510 can be used to clearly outline a reference region when a PIB tracer is used as the PET tracer, the reference region being the grey matter area of the cerebellum, the same or a different PC image (depending on the relevant period during which uptake is greatest in the required region of interest) may be similarly used to outline the same or a different reference region for a PET study using a different PET tracer. The selection of the particular PC image, and the time period divisions may vary depending on the kinetic behavior attributable to the particular PET tracer that is used.

At 412, the outline may be saved for future import into other images. At 414, the outline may be imported into another image, e.g., automatically (as will be explained below) or in response to user input. For example, the outline may be imported into a PC1 image, in which white matter regions are more dominant than in the PC2 image 510. The import into the PC1 image may be, for example, for analysis of the data represented in the PC1 image.

In an example embodiment of the present invention, the method of generating a reference region outline may include generating a PC image other than the PC2 image. The other PC image may be used to ensure that the region outlined at 410 is correct. For example, at 406, a PC3 image may be generated along with the PC2 image 510 in a manner substantially the same as that shown in FIG. 5, but for assignment of a highest weight to a different period, e.g., to period 1. The PC3 image may include highest pixel intensities at blood vessels. Generation of this other PC image (e.g., PC3) may be performed at any time after acquisition of the scan images 501 and before importing of the outline region at 425 into the PC3 image as will be described below. The PC3 image may be stored for later reference.

At 414, the outlined reference region may be imported into the PC3 image generated at 406. In particular, it is imported into a slice of the PC3 image corresponding to the slice of the PC2 image in which the reference region was outlined. At 416, it may be determined whether the outlined region is correct by determining whether the outline overlaps the high intensity pixels of the PC3 image representing the blood vessels. If there is no overlap, it may be assumed that the outline is correct. If there is overlap, it may be assumed that the outline is incorrect and the outline may be redrawn at 418 to shrink the outlined region so that it no longer overlaps the high intensity pixels of the PC3 image. This may be done automatically or manually.

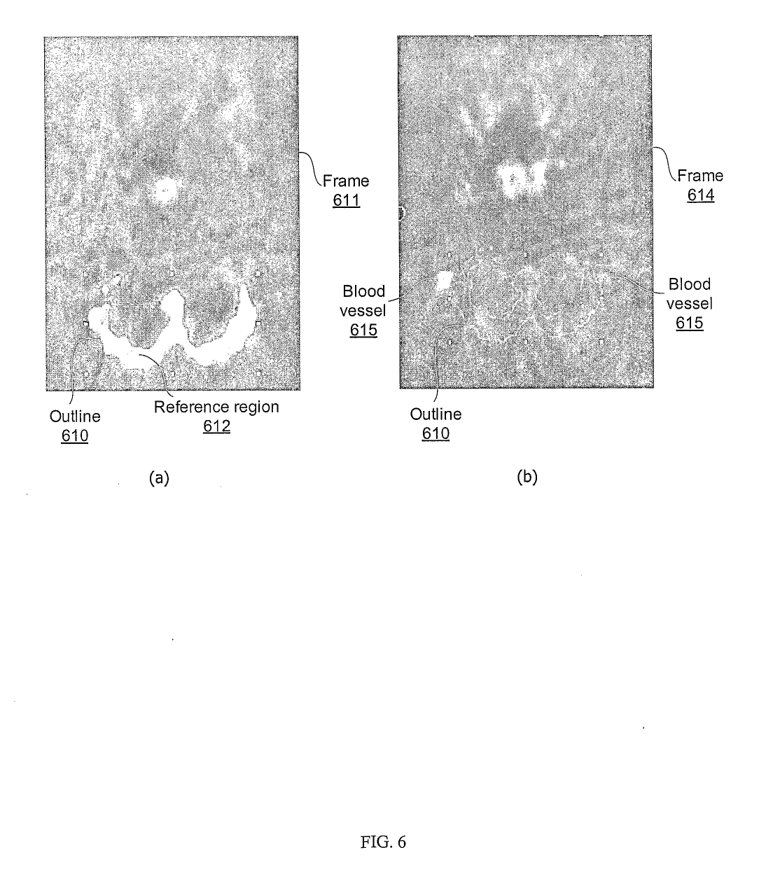

For example, part (a) of FIG. 6 illustrates an example of an outline 610 of a reference region 612 of a frame 611 of a PC2 image. Part (b) of FIG. 6 illustrates the outline 610 imported into a frame 614 of a PC3 image. Blood vessels 615 are outside of the outline 610. A determination that the outline 610 is correctly drawn may therefore be made.

While 416 has been explained with respect to the blood vessel region of a PC3 image, different PC images and different parts of a PC image may be used for determining whether the outlining at 410 is correct, depending on the PET tracer and depending on the regions of interest.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method for outlining a region of interest in a Positron Emission Tomography (PET) scan study, comprising:
scanning at least a part of a subject a plurality of times over a period of time that includes a plurality of sub-periods, wherein:
each scanning generates corresponding data representing an image of the at least the part of the subject, the image defined by pixel intensities; and
images represented by data generated during scans of different sub-periods accentuate different features of the at least the part of the subject;
generating data representing an image having pixel intensities derived at least mostly from one or more images generated by the scanning of a single one of the sub-periods;
determining which region of at least a portion of the image having the derived pixel intensities includes substantially higher pixel intensity values than other pixel intensity values of the at least a portion; and
marking a perimeter of the determined region as a region of interest outline.

2. The method of claim 1, wherein the images represented by the data generated by the scanning and the derived image are three dimensional images, the method further comprising:
selecting a two dimensional image from the three dimensional derived image, wherein the determining is performed with respect to the selected two dimensional image.

3. The method of claim 2, wherein:
the selecting includes discriminatorily selecting a predetermined subset of two dimensional images from the three dimensional derived image; and
the determining is performed separately for each of the selected two dimensional images, the method further comprising:
determining which particular one of the determined regions includes a largest surface area compared with the other of the determined regions; and
discriminatorily selecting the determined particular one of the determined regions for application of the marking the perimeter.

4. The method of claim 1, further comprising:
administering for ingestion a PET tracer, the scanning being performed after the ingestion;
wherein:
the tracer interacts, in a manner detectable by a scanner with which the scanning is performed, with different parts of the subject during the period of time; and
the plurality of sub-periods substantially corresponds to changes in the tracer's interaction in the detectable manner with the parts of the subject.

5. The method of claim 4, wherein the single one of the sub-periods substantially corresponds to domination of interaction by the tracer with a part of the subject predetermined to include the determined region.

6. The method of claim 4, wherein the sub-periods include a first sub-period dominated by interaction of the tracer in the detectable manner with a blood stream, a second sub-period dominated by interaction of the tracer in the detectable manner with grey matter areas of the subject's brain, and a third sub-period in which interaction of the tracer in the detectable manner with white matter areas of the subject's brain is more dominant than in the first and second sub-periods.

7. The method of claim 6, wherein:
the tracer is a Pittsburgh Compound-B (Pa) tracer;
the second sub-period is used as the single one of the sub-periods; and
the outline is of a grey matter cerebellum region.

8. The method of claim 7, wherein the outlined region is usable as a reference region for a brain study to detect Alzheimer's disease.

9. The method of claim 1, wherein the data representing the image having the derived pixel intensities are derived via Masked Volume Wise Principal Component Analysis (MVW-PCA).

10. The method of claim 1, wherein the data representing the image having the derived pixel intensities are derived solely from the one or more images generated by the scanning of the single one of the sub-periods.

11. The method of claim 1, further comprising:
generating data representing an image having pixel intensities derived at least mostly from one or more images generated by the scanning of one of the sub-periods different than the single one of the sub-periods;
importing the outline into the image having the pixel intensities derived at least mostly from the one or more images generated by the scanning of the different sub-period;
determining which region of at least a portion of the image having the pixel intensities derived at least mostly from the one or more images generated by the scanning of the different sub-period includes substantially higher pixel intensity values than other pixel intensity values of the at least a portion of the image derived at least mostly from the different sub-period;
determining whether the outline overlaps the determined region of the image derived at least mostly from the different sub-period;
determining whether the outline is correct based on the determination of whether the outline overlaps; and
modifying the outline if it is determined that the outline is incorrect.

12. The method of claim 11, wherein the determined region of the at least a portion of the image having the pixel intensities derived at least mostly from the one or more images generated by the scanning of the different sub-period includes a plurality of regions.

13. The method of claim 11, wherein the determined region of the at least a portion of the image having the pixel intensities derived at least mostly from the one or more images generated by the scanning of the different sub-period represents one or more blood vessels.

14. A computer-readable medium having stored thereon instructions adapted to be executed by a processor, the instructions which, when executed, cause the processor to perform a method for outlining a region of interest in a Positron Emission Tomography (PET) scan study, the method comprising:
during each of a plurality of scans of at least a part of a subject performed over a period of time that includes a plurality of sub-periods, generating corresponding data representing an image of the at least the part of the subject, the image defined by pixel intensities, wherein images represented by data generated during scans of different sub-periods accentuate different features of the at least the part of the subject;
generating data representing an image having pixel intensities derived at least mostly from one or more images generated by the scanning of a single one of the sub-periods;
determining which region of at least a portion of the image having the derived pixel intensities includes substantially higher pixel intensity values than other pixel intensity values of the at least a portion; and
marking a perimeter of the determined region as a region of interest outline.

15. A system for outlining a region of interest in a Positron Emission Tomography (PET) scan study, comprising:
a scanner for scanning at least a part of a subject a plurality of times over a period of time that includes a plurality of sub-periods, wherein:
each scanning generates corresponding data representing an image of the at least the part of the subject, the image defined by pixel intensities; and
images represented by data generated during scans of different sub-periods accentuate different features of the at least the part of the subject;
an arrangement for generating data representing an image having pixel intensities derived at least mostly from one or more images generated by the scanning of a single one of the sub-periods;
an arrangement for determining which region of at least a portion of the image having the derived pixel intensities includes substantially higher pixel intensity values than other pixel intensity values of the at least a portion; and
an arrangement for marking a perimeter of the determined region as a region of interest outline.

16. The system of claim 15, wherein the images represented by the data generated by the scanning and the derived image are three dimensional images, the system further comprising:
an arrangement for selecting a two dimensional image from the three dimensional derived image, wherein the determining is performed with respect to the selected two dimensional image.

17. The system of claim 16, wherein:
the selecting includes discriminatorily selecting a predetermined subset of two dimensional images from the three dimensional derived image; and
the determining is performed separately for each of the selected two dimensional images, the system further comprising:
an arrangement for determining which particular one of the determined regions includes a largest surface area compared with the other of the determined regions; and
an arrangement for discriminatorily selecting the determined particular one of the determined regions for application of the marking the perimeter.

18. The system of claim 15, wherein:
a PET tracer is ingested, the scanning being performed after the ingestion;
the tracer interacts, in a manner detectable by the scanner, with different parts of the subject during the period of time; and
the plurality of sub-periods substantially corresponds to changes in the tracer's interaction in the detectable manner with the parts of the subject.

19. The system of claim 18, wherein the single one of the sub-periods substantially corresponds to domination of interaction by the tracer with a part of the subject predetermined to include the determined region.

20. The system of claim 18, wherein the sub-periods include a first sub-period dominated by interaction of the tracer in the detectable manner with a blood stream, a second sub-period dominated by interaction of the tracer in the detectable manner with grey matter areas of the subject's brain, and a third sub-period in which interaction of the tracer in the detectable manner with white matter areas of the subject's brain is more dominant than in the first and second sub-periods.

21. The system of claim 20, wherein:
the tracer is a Pittsburgh Compound-B (PIB) tracer;
the second sub-period is used as the single one of the sub-periods; and
the outline is of a grey matter cerebellum region.

22. The system of claim 21, wherein the outlined region is usable as a reference region for a brain study to detect Alzheimer's disease.

23. The system of claim 15, wherein the data representing the image having the derived pixel intensities are derived via Masked Volume Wise Principal Component Analysis (MVW-PCA).

24. The system of claim 15, wherein the data representing the image having the derived pixel intensities are derived solely from the one or more images generated by the scanning of the single one of the sub-periods.

25. The system of claim 15, further comprising:
an arrangement for generating data representing an image having pixel intensities derived at least mostly from one or more images generated by the scanning of one of the sub-periods different than the single one of the sub-periods;
an arrangement for importing the outline into the image having the pixel intensities derived at least mostly from the one or more images generated by the scanning of the different sub-period;
an arrangement for determining which region of at least a portion of the image having the pixel intensities derived at least mostly from the one or more images generated by the scanning of the different sub-period includes substantially higher pixel intensity values than other pixel intensity values of the at least a portion of the image derived at least mostly from the different sub-period;
an arrangement for determining whether the outline overlaps the determined region of the image derived at least mostly from the different sub-period;
an arrangement for determining whether the outline is correct based on the determination of whether the outline overlaps; and
an arrangement for modifying the outline if it is determined that the outline is incorrect.

26. A method for outlining a region of interest in a Positron Emission Tomography (PET) scan study, comprising:
dividing a plurality of scanned images into groups corresponding to different defined periods of scan time;
performing Masked Volume Wise Principal Component Analysis (MVW-PCA) on the plurality of scanned images to generate an image emphasizing images of one of the groups; and
marking an outline in the generated image solely based on pixel intensity values of the generated image.
